(19) United States
(12) Patent Application Publication
(10) Pub. No.: US 2018/0113603 A1
(43) Pub. Date: Apr. 26, 2018

(54) FLOATING ASSET IN A WORKSPACE

(71) Applicant: PRYSM, INC., San Jose, CA (US)

(72) Inventor: Christopher T. Poore, Zionsville, IN (US)

(21) Appl. No.: 15/334,196

(22) Filed: Oct. 25, 2016

(51) Int. Cl. G06F 3/0484; G06F 3/0482; G06F 3/0488

(52) U.S. Cl. CPC G06F 3/04847; G06F 3/0482; G06F 2203/04808; G06F 3/04845; G06F 3/04883

(57) ABSTRACT

A communication infrastructure causes a workspace comprising a plurality of assets to be displayed at each appliance in a session. A float setting may be applied by a user to an asset to produce a floating asset. A floating asset is assigned a z-index that indicates a higher stacking order than all non-floating assets in the same workspace regardless of any subsequent user interactions with the floating asset and/or non-floating assets. Thus, the float setting for the asset persists during the session, until the float setting is turned off by the user. In this manner, a floating asset is never obscured by any non-floating asset in the same workspace during the session, since the persistent higher stacking order of the floating asset effectively prevents displaying of a non-floating asset in front of the floating asset during the session.

### BACKGROUND OF THE INVENTION

### Field of the Invention

The present invention generally relates to displaying digital content and, more specifically, to displaying a floating asset in a workspace.

### Description of the Related Art

Currently, digital content may be shared across different computer devices using a variety of techniques. As a general matter, though, during a content sharing session (collaborative session), a shared workspace that includes various types of digital content (assets) may be simultaneously displayed on multiple computer devices at different physical locations. For example, the shared workspace may be simultaneously displayed on a local computer device (used by a local user) as well as one or more remote computer devices (used by one or more remote users). Further, the assets included in the shared workspace typically can be accessed and used by the different participants in the collaborative session.

When a given user interacts with a particular asset in the shared workspace during a collaborative session, the user's interactions with the asset are reflected/mirrored on each computer device that accesses and displays the shared workspace. For example, a local user may move asset B so that it overlaps asset A, in which case, asset B is typically displayed in the foreground and in front of asset A at the local computer device and at each of the remote computer devices. A large number of such user interactions with the assets may occur in the shared workspace, where the asset having the most recent user interaction is continually displayed in the foreground and in front of the other assets in the shared workspace on all computer devices participating in the collaborative session.

A drawback to such conventional content sharing approaches occurs, for example, when one user (presenter) on a particular computer device is giving a presentation and discussing a primary asset of particular importance. During the presentation, other users on other computer devices in the collaborative session may interact with other assets (secondary assets) in the workspace. If one of those other users interacts with a secondary asset that spatially overlaps with the primary asset or moves or resizes a secondary asset to spatially overlap the primary asset, the content sharing system typically causes the secondary asset to be displayed in front of the primary asset, as described above. Consequently, the second asset can end up obscuring the primary asset the presenter is discussing.

More generally, obscuring any primary asset having particular importance may be undesirable regardless of whether a user is in a presentation or non-presentation situation or in a collaborative or non-collaborative (solo) session. For example, in a solo session with only a local user at a local computer device, the local user may interact with secondary assets in a way that unintentionally causes one of the secondary assets to obscure the primary asset in the workspace.

Once obscured by a secondary asset, whether in collaborative or non-collaborative session, a user must interact with the primary asset to bring the primary asset back into the foreground and cause the primary asset to be displayed in front of the secondary asset. Because primary assets can become obscured by secondary assets quite frequently, having to interact with the primary assets continually to keep them in the foreground can become tedious to users, resulting in a less than optimal user experience.

As the foregoing illustrates, what is needed in the art are more effective techniques for displaying digital assets in a workspace.

### SUMMARY OF THE INVENTION

Various embodiments of the present invention include a computer-implemented method for displaying assets in a workspace. The method includes assigning a float setting to a first asset to produce a first floating asset in a first workspace. The method further includes, subsequently detecting an interaction with a second asset in the first workspace and in response, displaying the first floating asset in the first workspace with a higher stacking order than the second asset.

At least one advantage of the disclosed technique is that an asset may be selected as a floating asset and will have a higher stacking order than non-floating assets, whereby the floating asset is persistently displayed in the foreground in front of non-floating assets in the workspace.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a display system configured to implement one or more aspects of the present invention;

FIG. 2 is a conceptual diagram of a collaboration system configured to share content streams across display systems, according to various embodiments of the present invention;

FIG. 3 is a more detailed block diagram of the streaming infrastructure of FIG. 2, according to various embodiments of the present invention;

FIG. 4 is a more detailed block diagram of the messaging infrastructure of FIG. 2, according to one embodiment of the present invention;

FIG. 5 is a conceptual diagram of a collaboration system configured to display a shared workspace that implements a floating asset feature, according to various embodiments of the present invention;

FIG. 6A shows a conceptual diagram of an initial/first asset display data structure, according to various embodiments of the present invention;

FIG. 6B is a screenshot of a first temporal rendering of a workspace based on the first asset display data structure of FIG. 6A, according to various embodiments of the present invention;

FIG. 6C shows a conceptual diagram of a second asset display data structure, according to various embodiments of the present invention;

FIG. 6D is a screenshot of a second temporal rendering of a workspace based on the second asset display data structure of FIG. 6C, according to various embodiments of the present invention;

FIG. 6E shows a conceptual diagram of an updated third asset display data structure, according to various embodiments of the present invention;

FIG. 6F is a screenshot of a third temporal rendering of a workspace based on the third asset display data structure of FIG. 6E, according to various embodiments of the present invention;

FIG. 6G shows a conceptual diagram of an updated fourth asset display data structure, according to various embodiments of the present invention;

FIG. 6H is a screenshot of a fourth temporal rendering of a workspace based on the fourth asset display data structure of FIG. 6G, according to various embodiments of the present invention;

FIG. 6I shows a conceptual diagram of a fifth asset display data structure, according to various embodiments of the present invention;

FIG. 6J is a screenshot of a fifth temporal rendering of a workspace based on the fifth asset display data structure of FIG. 6I, according to various embodiments of the present invention; and

FIGS. 7A-7B set forth a flow diagram of method steps for displaying a floating asset in a workspace, according to various embodiments of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

The following description is divided into two sub-sections. Section I is a system overview describing a collaborative appliance and collaboration system. Section II describes techniques for displaying a floating asset in a workspace.

### System Overview

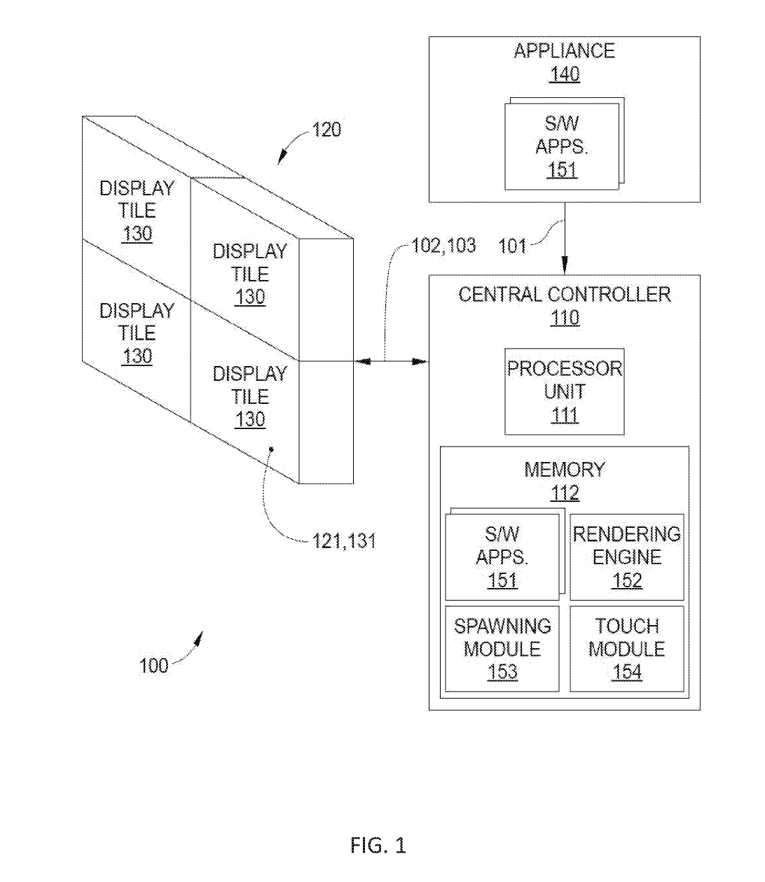

FIG. 1 is a block diagram of a display system 100 configured to implement one or more aspects of the present invention. As shown, display system 100 includes, without limitation, a central controller 110, a display 120, and an appliance 140. In some embodiments, display 120 is a display wall that includes multiple display tiles. Central controller 110 receives digital image content 101 from the appliance 140 or from an information network or other data routing device, and converts said input into image data signals 102. Thus, digital image content 101 may be generated locally, with appliance 140, or from some other location. For example, when display system 100 is used for remote conferencing, digital image content 101 may be received via any technically feasible communications or information network, wired or wireless, that allows data exchange, such as a wide area network (WAN), a local area network (LAN), a wireless (Wi-Fi) network, and/or the Internet, among others.

Central controller 110 includes a processor unit 111 and memory 112. Processor unit 111 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processor unit 111 may be any technically feasible hardware unit capable of processing data and/or executing program code and software applications to facilitate operation of display system 100, including software applications 151, rendering engine 152, spawning module 153, and touch module 154. The processor unit 111 executes software and performs the functions and operations described herein. During operation, software applications 151, rendering engine 152, spawning module 153, and touch module 154 may reside in memory 112. Alternatively or additionally, software applications 151 may also reside in appliance 140. In some embodiments, one or more of 151-154 may be implemented in firmware, either in central controller 110 and/or in other components of display system 100.

Memory 112 may include volatile memory, such as a random access memory (RAM) module, and non-volatile memory, such as a flash memory unit, a read-only memory (ROM), or a magnetic or optical disk drive, or any other type of memory unit or combination thereof. The memory unit 112 is configured to store software application(s) and data. Instructions from the software constructs within the memory unit 112 are executed by processors 111 to enable the inventive operations and functions described herein. Memory 112 is configured to store any software programs, operating system, drivers, and the like, that facilitate operation of display system 100, including software applications 151, rendering engine 152, spawning module 153, and touch module 154.

Display 120 may include the display surface or surfaces of any technically feasible display device or system type, including but not limited to the display surface of a light-emitting diode (LED) display, a digital light (DLP) or other projection displays, a liquid crystal display (LCD), optical light emitting diode display (OLED), laser-phosphor display (LPD) and/or a stereo 3D display all arranged as a single stand-alone display, head mounted display or as a single or multi-screen tiled array of displays. Display sizes may range from smaller handheld or head mounted display devices to full wall displays. In the example illustrated in FIG. 1, display 120 includes a plurality of display light engine and screen tiles 130 mounted in a 2×2 array. Other configurations and array dimensions of multiple electronic display devices, e.g. 1×4, 2×3, 5×6, etc., also fall within the scope of the present invention.

In operation, display 120 displays image data signals 102 output from controller 110. For a tiled display, as illustrated in FIG. 1, image data signals 102 are appropriately distributed among display tiles 130 such that a coherent image is displayed on a display surface 121 of display 120. Display surface 121 typically includes the combined display surfaces of display tiles 130. In addition, display 120 includes a touch-sensitive surface 131 that extends across part or all surface area of display tiles 130. In one embodiment, touch-sensitive surface 131 senses touch by detecting interference between a user and one or more beams of light, including, e.g., infrared laser beams. In other embodiments, touch sensitive surface 131 may rely on capacitive touch techniques, including surface capacitance, projected capacitance, or mutual capacitance, as well as optical techniques, acoustic wave-based touch detection, resistive touch approaches, and so forth, without limitation. Touch-sensitive surface 131 enables users to interact with assets displayed on the wall implementing touch gestures including tapping, dragging, swiping, and pinching. These touch gestures may replace or supplement the use of typical peripheral I/O devices, although touch-sensitive surface 131 may receive inputs from such devices, as well. In this regard, the display system 100 may also include typical peripheral I/O devices (not shown), such as an external keyboard or mouse, which also enable users to interact with assets.

In the context of this disclosure, an “asset” may refer to any interactive renderable digital content that can be displayed on a display, such as display 120, among others. Interactive renderable content is generally derived from one or more persistent or non-persistent content streams that include sequential frames of video data, corresponding audio data, metadata, flowable/reflowable unstructured content, and potentially other types of data. Generally, an asset may be displayed within a dynamically adjustable presentation window. For simplicity, an asset and corresponding dynamically adjustable presentation window are generally referred to herein as a single entity, i.e., an “asset.” Assets may comprise content sources that are file-based, application-based (e.g., web-based), or Live Source. Assets may include images, videos, web browsers, documents, applications, instances of applications, renderings of laptop screens, presentation slides, any other graphical user interface (GUI) of a software application, and the like. An asset generally includes at least one display output generated by a software application, such as a GUI of the software application. In one embodiment, the display output is a portion of a content stream. In addition, an asset is generally configured to receive one or more software application inputs via a gesture-sensitive display surface of a collaboration client system 140, i.e., inputs received via the gesture-sensitive display surface are received by the asset and treated as input for the software application associated with the asset. Thus, unlike a fixed image, an asset is a dynamic element that enables interaction with the software application associated with the asset, for example, for manipulation of the asset. For example, an asset may include select buttons, pull-down menus, control sliders, etc. that are associated with the software application and can provide inputs to the software application.

As also referred to herein, a “workspace” or “shared workspace” is a virtual digital canvas on which assets associated therewith, and their corresponding content streams, are displayed within a suitable dynamic “viewport window” on display 120. Thus, a shared workspace may comprise one or more associated assets (each asset displayed within a presentation window), whereby the entire shared workspace is displayed within a dynamically adjustable viewport window. A shared workspace may be displayed in the entire potential render area/space of the display 120, so that only a single shared workspace can be displayed on the surface thereof. In this case, the area of the viewport window that displays the shared workspace comprises the entire render area of the display 120. In other embodiments, however, the shared workspace and the viewport window may be displayed in a sub-area of the total display area of the display 120 that does not comprise the entire render area of the display 120. For example, multiple shared workspaces may be displayed in multiple viewport windows on the display 120 concurrently, whereby each shared workspace and viewport window does not correspond to the entire display surface. Each asset associated with a shared workspace, and content stream(s) corresponding to the asset, are displayed in a presentation window according to defined dimensions (height and width) and a location within the shared workspace and viewport window. The asset and presentation window dimensions and location may also be user-adjustable. As also referred to herein, a “project” may comprise a set of one or more related shared workspaces.

Touch-sensitive surface 131 may be a “multi-touch” surface, which can recognize more than one point of contact on display 120, enabling the recognition of complex gestures, such as two or three-finger swipes, pinch gestures, and rotation gestures as well as multiuser two, four, six etc. hands touch or gestures. Thus, one or more users may interact with assets on display 120 implementing touch gestures such as dragging to reposition assets on the screen, tapping assets to display menu options, swiping to page through assets, or implementing pinch gestures to resize assets. Multiple users may also interact with assets on the screen simultaneously. Again, examples of assets include application environments, images, videos, web browsers, documents, applications, instances of applications, mirroring or renderings of laptop screens, presentation slides, content streams, and so forth. Touch signals 103 are sent from a touch panel associated with a display 120 to central controller 110 for processing and interpretation.

It will be appreciated that the system shown herein is illustrative only and that variations and modifications are possible. For example, any of software applications 151, rendering engine 152, spawning module 153, and touch module 154 may reside outside of central controller 110.

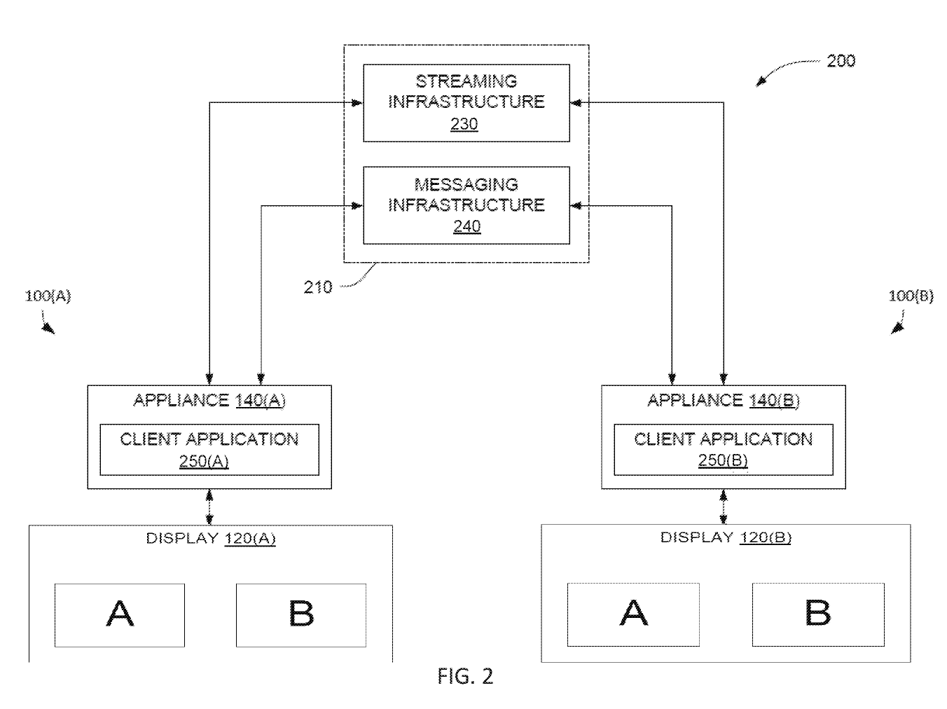

FIG. 2 is a conceptual diagram of a collaboration system 200 configured to share content streams across display systems, according to various embodiments of the present invention. As shown, collaboration system 200 includes, without limitation, display systems 100A and 100B coupled together via a communication infrastructure 210. As shown in FIG. 2, the communication infrastructure 210 includes streaming infrastructure 230 and messaging infrastructure 240. Additionally, display system 100A is shown to include appliance 140A as well as display 120A, and display system 100B is shown to include appliance 140B as well as display 120B. For illustrative purposes, the appliances 140A and 140B each include a central controller 110 (not shown). In one embodiment, each of displays 120A and/or 120B represents a different instance of display 120 of FIG. 1 Appliance devices 140A and 140B include client applications 250A and 250B, respectively.

Display system 100A is configured to share a content stream A, via communication infrastructure 210, with display system 100B. In response, display system 100B is configured to retrieve content stream A from communication infrastructure 210 and to display that content stream on display 120B with its content stream B. Likewise, display system 100B is configured to share content stream B, via communication infrastructure 210, with display system 100A. In response, display system 100A is configured to retrieve content stream B from communication infrastructure 210 and to display that content stream on display 120A with its content stream A. In this fashion, display systems 100A and 100B are configured to coordinate with one another to generate a shared workspace that includes content streams A and B. Content streams A and B may be used to generate different assets rendered within the shared workspace. In one embodiment, each of display systems 100A and 100B perform a similar process to reconstruct the shared workspace, thereby generating a local version of that shared workspace that is similar to other local versions of the shared workspace reconstructed at other display systems. As a general matter, the functionality of display systems 100A and 100B are coordinated by client applications 250A and 250B, respectively.

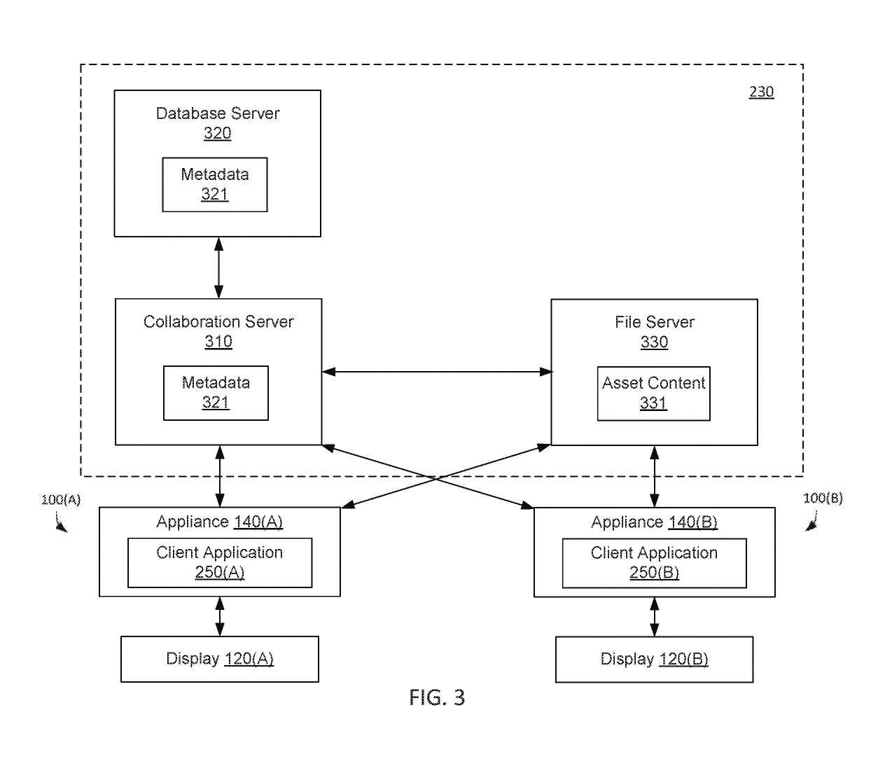

Client applications 250A and 250B are software programs that generally reside within a memory (not shown) associated with the respective appliances 140A and 140B. Client applications 250A and 250B may be executed by a processor unit (not shown) included within the respective computing appliances 140. When executed, client applications 250A and 250B setup and manage the shared workspace discussed above in conjunction with FIG. 2, which, again, includes content streams A and B. In one embodiment, the shared workspace is defined by metadata that is accessible by both display systems 100A and 100B. Each such display system 100 may generate a local version of the shared workspace that is substantially synchronized with the other local version, based on that metadata (discussed below in relation to FIG. 3).

In doing so, client application 250A is configured to transmit content stream A to streaming infrastructure 230 for subsequent streaming to display system 100B. Client application 250A also transmits a message to display system 100B, via messaging infrastructure 240, that indicates to display system 100B that content stream A is available and can be accessed at a location reflected in the message. In like fashion, client application 250B is configured to transmit content stream B to streaming infrastructure 230 for subsequent streaming to display system 100A. Client application 250B also transmits a message to display system 100A, via messaging infrastructure 240, that indicates to display system 100A that content stream B is available and can be accessed at a location reflected in the message. The message indicates that access may occur from a location within streaming infrastructure 230.

Client application 250A may also broadcast a message via messaging infrastructure 240 to display system 100B that specifies various attributes associated with content stream A that may be used to display content stream A. The attributes may include a location/position, a picture size, an aspect ratio, or a resolution with which to display content stream A on display 120B, among others, and may be included within metadata described below in relation to FIG. 3. Client application 250B may extract the attributes from messaging infrastructure 240, and then display content stream A at a particular position on display 120B, with a specific picture size, aspect ratio, and resolution, as provided by messaging infrastructure 240. Through this technique, display system 100A is capable of sharing content stream A with display system 100B. Display system 100B is configured to perform a complimentary technique in order to share content stream B with display system 100A.

Client applications 250A and 250B are thus configured to perform similar techniques in order to share content streams A and B, respectively with one another. When client application 250A renders content stream A on display 120A and, also, streams content stream B from streaming infrastructure 230, display system 100A thus constructs a version of a shared workspace that includes content stream A and B. Similarly, when client application 250B renders content stream B on display 120B and, also streams content stream A from streaming infrastructure 230, display system 100A similarly constructs a version of that shared workspace that includes content streams A and B.

The display systems 100A and 100B discussed herein are generally coupled together via streaming infrastructure 230 and messaging infrastructure 240. Each of these different infrastructures may include hardware that is cloud-based and/or collocated on-premises with the various display systems. However, persons skilled in the art will recognize that a wide variety of different approaches may be implemented to stream content streams and transport messages/messages between display systems.

FIG. 3 is a more detailed block diagram of the streaming infrastructure of FIG. 2, according to various embodiments of the present invention. Streaming infrastructure 230 may include a collaboration server 310, a database server 320, and a file server 330. Each server may comprise a computer device having a processor (such as processor unit 111 described in relation to FIG. 1) and a memory (such as memory 112 described in relation to FIG. 1), the processor executing software for performing functions and operations described herein. Collaboration server 310, database server 320, and file server 330 may be implemented as shown as separate and distinct computing devices/structures coupled to each other and to appliance systems 140 via a network. Alternatively, the functionality of collaboration server 310, database server 320, and file server 330 may be implemented as a single computing device/structure in a single location, or in any other technically feasible combination of structures. Further, one or more of collaboration server 310, database server 320, and/or file server 330 may be implemented as a distributed computing system. The network may be via any technically feasible communications or information network, wired or wireless, that allows data exchange, such as a wide area network (WAN), a local area network (LAN), a wireless (WiFi) network, and/or the Internet, among others.

Collaboration server 310 coordinates the flow of information between the various appliances 140, database server 320, and file server 330. Thus, in some embodiments, collaboration server 310 is a streaming server for appliances 140. In some embodiments, the application program interface (API) endpoint for appliances 140 and/or business logic associated with streaming infrastructure 230 resides in collaboration server 310. In addition, collaboration server 310 receives requests from appliances 140 and can send notifications to appliances 140. Therefore, there is generally a two-way connection between collaboration server 310 and each of appliances 140. Alternatively or additionally, appliances 140 may make requests on collaboration server 310 through the API. For example, during a collaborative work session on a particular project via collaboration system 200, a collaboration appliance 140 may send a request to collaboration server 310 for information associated with an asset to display the asset in a shared workspace of the particular project.

Database server 320 (as well as collaboration server 310) may store metadata 321 associated with collaboration system 200, such as metadata for specific assets, shared workspaces, and/or projects. For example, such metadata may include which assets are associated with a particular shared workspace, which shared workspaces are associated with a particular project, the state of various settings for each shared workspace, annotations made to specific assets, etc. Metadata 321 may also include aspect ratio metadata and asset metadata for each asset.

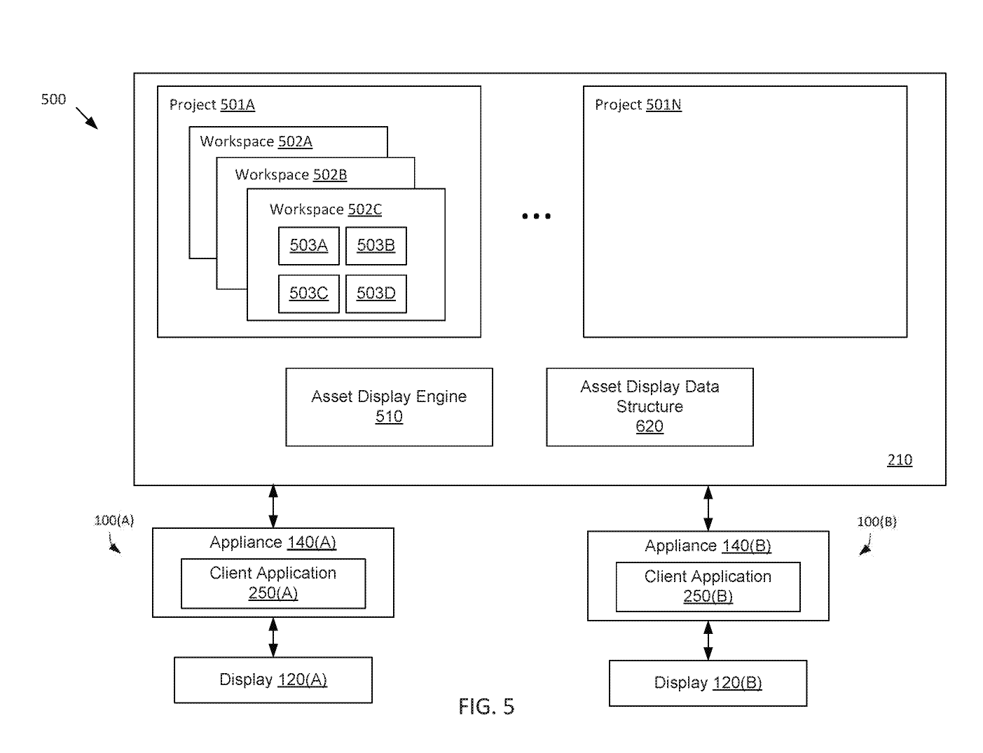

Asset metadata for an asset may specify a location/position and dimensions/size of the asset within an associated shared workspace. The asset metadata indicates the position and size of an asset, for example, implementing horizontal and vertical (x and y) coordinate values. In some embodiments, the asset metadata may express the position and size of an asset in percentage values. In such embodiments, the size (width and height) and position (x, y) of the asset is represented in terms of percent locations along an x-axis (horizontal axis) and y-axis (vertical axis) of the associated shared workspace. For example, the position and size of an asset may be expressed as percentages of the shared workspace width and shared workspace height. The horizontal and vertical (x and y) coordinate values may correspond to a predetermined point on the asset, such as the position of the upper left corner of the asset. When multiple display systems 100 separately display a shared workspace, each display system 100 may configure the local version of the shared workspace based on the received metadata. In some embodiments, the asset metadata may further include a z-index and a float setting for each asset in a workspace for helping to determine a stacking/layering order for displaying/rendering multiple assets in the same workspace. The asset metadata required for determining a stacking/layering order for assets of a workspace may be stored to an asset display data structure, discussed below in relation to FIG. 5.

File server 330 is the physical storage location for some or all asset content 331 that are rendered as files, such as documents, images, videos, applications, and the like. In some embodiments, file server 330 can receive requests for asset content 331 directly from appliances 140. For example, an asset, such as a word-processing document, may be associated with a shared workspace that is displayed on the display 120 of first and second appliances 140. When the asset is modified by a user at the first collaboration appliance 140A, metadata for a file associated with the asset is updated in file server 330 by collaboration server 310, the second collaboration appliance 140B downloads the updated metadata for the file from file server 330, and the asset is then displayed, as updated, on the gesture-sensitive display surface of the second collaboration appliance 140B. Thus, file copies of all assets for a particular shared workspace and project may be stored at the file server 330, as well as stored at each appliance 140 that is collaborating on a project.

Each of appliances 140 is an instance of a collaborative multi-media platform disposed at a different location in collaboration system 200. Each collaboration appliance 140 is configured to provide a digital system that can be mirrored at one or more additional and remotely located appliances 140. Thus, collaboration clients facilitate the collaborative modification of assets, shared workspaces, and/or complete presentations or other projects, as well as the presentation thereof.

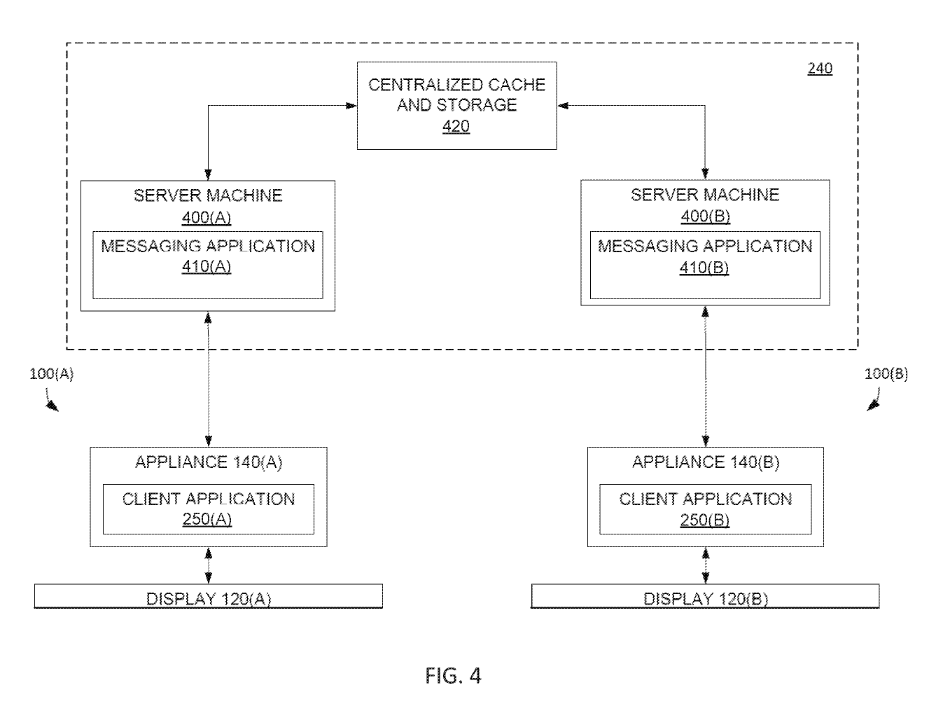

FIG. 4 is a more detailed block diagram of the messaging infrastructure of FIG. 2, according to one embodiment of the present invention. As shown, messaging infrastructure 240 includes server machines 400A and 400B coupled together via centralized cache and storage 420. Server machine 400A is coupled to appliance 140A and includes a messaging application 410A. Server machine 400B is coupled to appliance 140B and includes a messaging application 410B.

Server machines 400A and 400B are generally cloud-based or on-premises computing devices that include memory (such as memory 112 described in relation to FIG. 1) and processor units (such as processor unit 111 described in relation to FIG. 1) configured to store and execute messaging applications 410A and 410B, respectively. Messaging applications 410A and 410B are configured to generate real-time socket connections with appliances 140A and 140B, respectively, to allow messages to be transported quickly between the appliances 140. In one embodiment, messaging applications 410A and 410B are implemented as ASP.NET applications and rely on signalR WebSockets to accomplish fast, real-time messaging.

Centralized cache and storage 420 provide a persistent messaging back-end through which messages can be exchanged between messaging applications 410A and 410B. In one embodiment, centralized cache and storage includes a Redis cache backed by a SQL database. Messaging applications 410A and 4106 may be configured to periodically poll centralized cache and storage 420 for new messages, thereby allowing messages to be delivered to those applications quickly.

In operation, when display system 100A transmits a message indicating that content stream A is available on streaming infrastructure 510, as described above, display system 100A transmits that message to messaging application 410A. Messaging application 410A may then relay the message to centralized cache and storage 420. Messaging application 410B polls centralized cache and storage 420 periodically, and may thus determine that that the message has arrived. Messaging application 410B then relays the message to display system 1006. Display system 1006 may then parse the message to retrieve an identifier associated with display system 100A, and then stream content associated with display system 100A from streaming server 610.

### Floating Asset Feature

FIG. 5 is a conceptual diagram of a collaboration system 500 configured to display a shared workspace that implements a floating asset feature, according to various embodiments of the present invention. As shown, collaboration system 500 includes, without limitation, a communication infrastructure 210 connected with one or more display systems 100 (such as 100A and 100B), each display system 100 comprising an appliance 140 (such as 140A and 140B, respectively) and a display 120 (such as 120A, and 120B, respectively). Each appliance 140 comprises a client computing device that includes a central controller 110 (not shown). As used herein, an appliance 140 may be referred to as a client device and these terms may be used interchangeably. For example, an appliance 140 may comprise a workstation, a laptop computer, a tablet, cell phone or other hand-held device, or any other type of computing device.

As described above in relation to FIGS. 1-4, the communication infrastructure 210 may store one or more projects 501, each project 501 comprising a set of one or more associated workspaces 502. Each workspace 502 may include one or more associated assets 503. For example, the projects 501, workspaces 502, and assets 503 may be stored in the collaboration server 310, database server 320, and/or file server 330 of the communication infrastructure 210. As described above, during a collaboration session, the communication infrastructure 210 may work in conjunction with the appliances 140 to share and display a shared workspace 502 of a project 501 across multiple display systems 100. Each appliance 140 in the collaboration session may display one or more assets 503 of the shared workspace 502 according to the asset metadata (stored to the communication infrastructure 210) associated with each asset 503. The communication infrastructure 210 may also work in conjunction with the appliances 140 to mirror user interactions of assets 503 of the shared workspace 502 at any appliance 140 across the multiple display systems 100 and appliances 140. For example, a user interaction of an asset (e.g., selecting, moving, or resizing the asset) at a first appliance 140A is displayed/reflected at the first appliance 140A and also is displayed/reflected at the second appliance 140A via the communication infrastructure 210.

In some embodiments, the communication infrastructure 210 also executes an asset display engine 510 that determines the display appearance of the assets in the workspace based on an asset display data structure 620. For example, the asset display engine 510 may reside and execute within the collaboration server 310 and the asset display data structure 620 may be stored on the collaboration server 310 and/or the database server 320. The communication infrastructure 210 may maintain and update an asset display data structure 620 for each workspace 502 of each project 501 during collaborative or non-collaborative (solo) sessions for the project 501. The communication infrastructure 210 may update an asset display data structure 620 for a workspace 502 to reflect user interactions with assets 503 of the workspace 502 during the session for a project 501. The communication infrastructure 210 may also persist/store the asset display data structure 620 of each workspace 502 of each project 501 so that the last state of the asset display data structure 620 prior to the closing/ending of the session is retained for the next session either individually for each workspace uniquely within a project or across all workspaces within a project.

For each asset of a workspace, the asset display engine 510 may determine the position and size of the asset as displayed in the workspace using the asset display data structure 620. In this regard, the asset display data structure 620 may include asset metadata for determining the display position and size of each asset in the workspace, such as x and y coordinate values and height and width values for each asset in the workspace. The asset display engine 510 may also determine a stacking/layering order for displaying/rendering displaying multiple assets 503 of the workspace 502 based on the asset display data structure 620. In some embodiments, asset display data structure 620 may include asset metadata for determining the stacking/layering order for multiple assets 503 of a workspace 502, such as a z-index value and float setting for each asset in the workspace.

The communication infrastructure 210 may transmit the asset display data structure 620 to each of the appliances 140. In turn, each of the appliances 140 then displays/renders the shared workspace and the assets contained therein in the display 120 according to the asset display data structure 620. In response to each user interaction of an asset in the shared workspace at any of the appliances 140, the communication infrastructure 210 may update the asset display data structure 620 according to the user interaction and transmit the updated asset display data structure 620 to each of the appliances 140. In turn, each of the appliances 140 then displays/renders the shared workspace and the assets contained therein in the display 120 according to the updated asset display data structure 620. In this manner, user interactions and changes to the assets at any of the appliances 140 is mirrored to the other appliances 140 so that all appliances 140 in the session display the user interactions and changes to the assets.

In this regard, a collaborative or solo session may be considered a sequence of temporal renderings of the workspace, each rendering being a distinct temporal rendering of the workspace. For example, a new temporal rendering of the workspace may be caused to be produced after and in response to the communication infrastructure 210 receiving a user interaction with an asset of the workspace at any of the appliances 140, and then updating the asset display data structure 620 according to the received user interaction. User interactions may include, for example, selecting, moving, or resizing an asset, or selecting or unselecting a float setting for an asset. Each new temporal rendering of the workspace is then generated at each appliance 140 based on the updated asset display data structure 620.

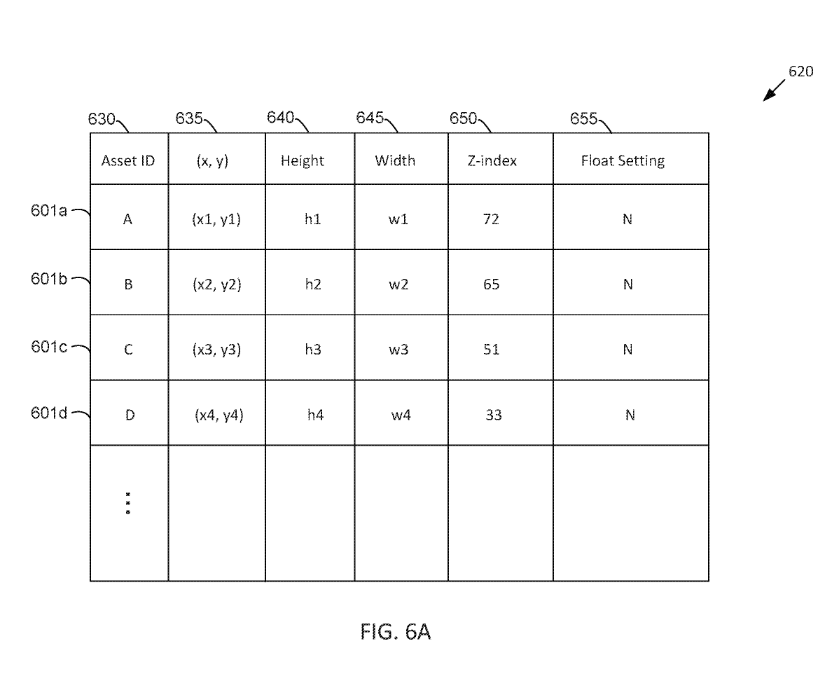

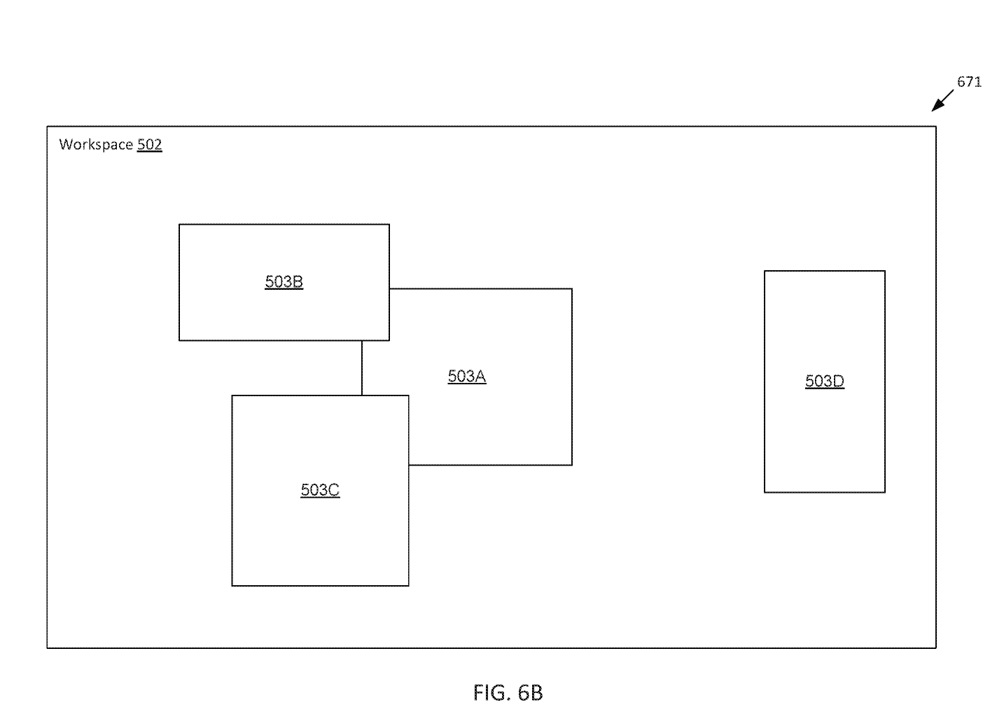

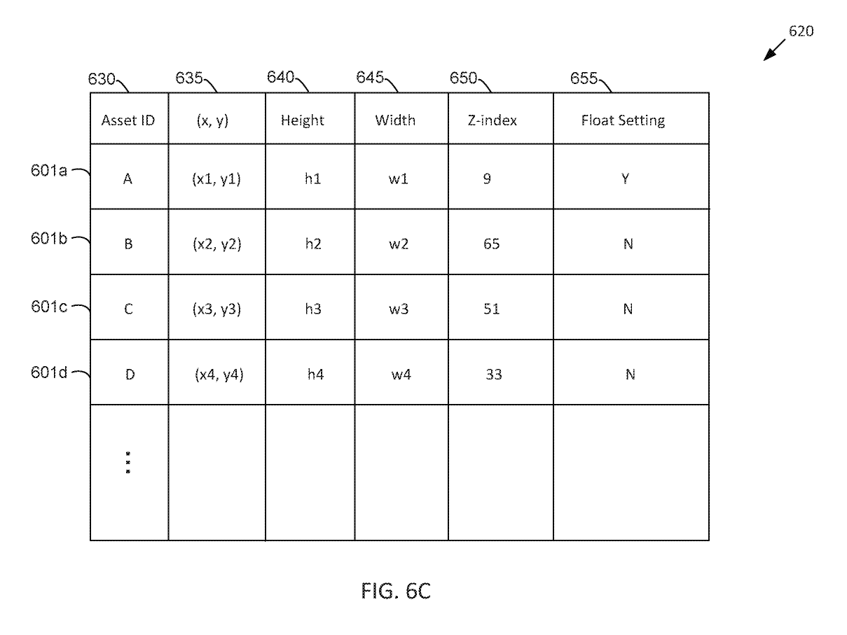

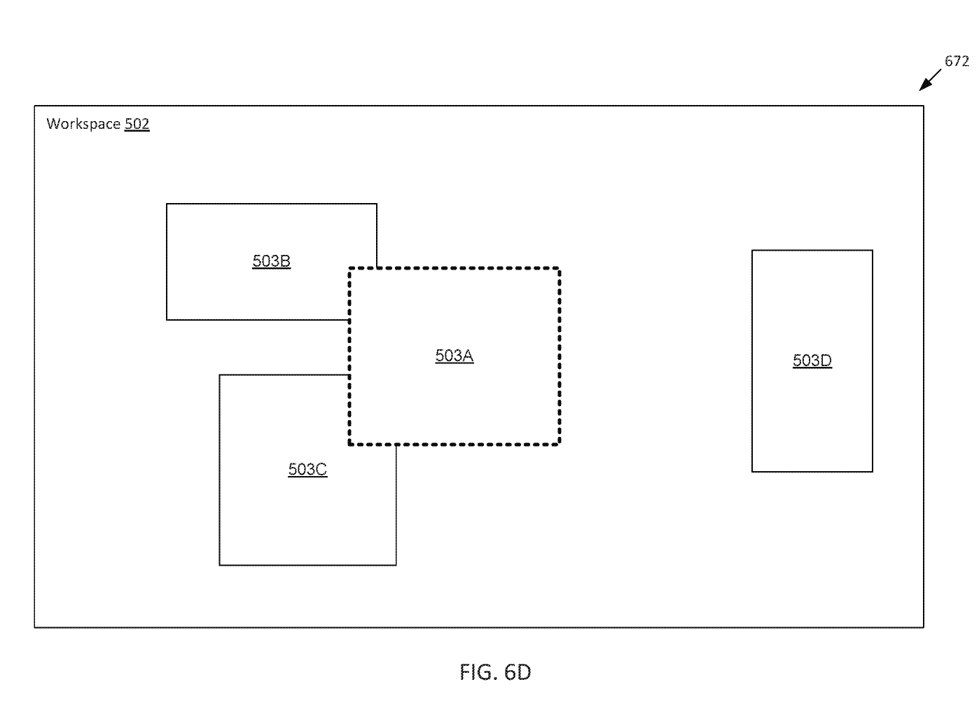

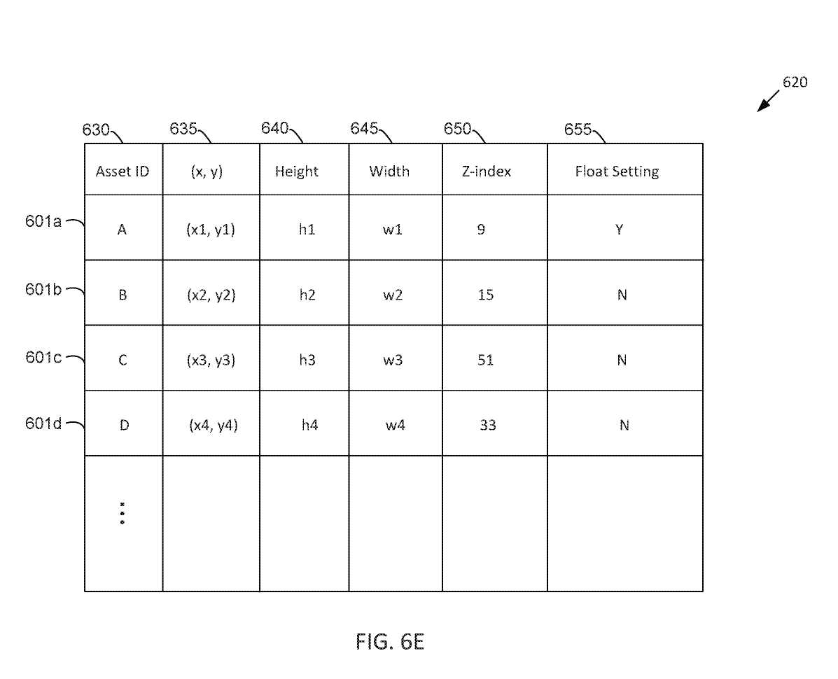

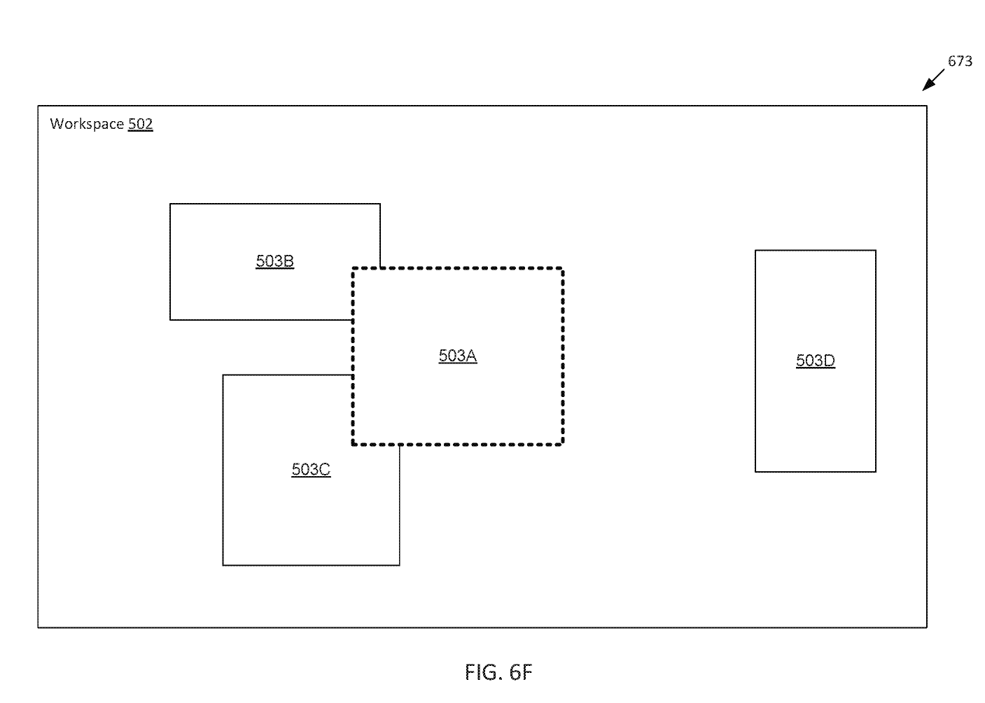

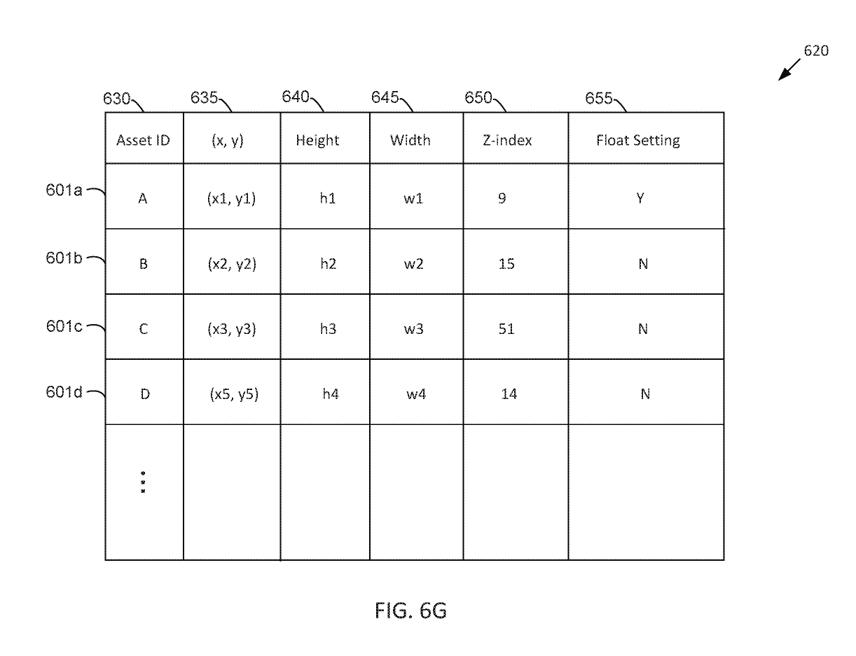

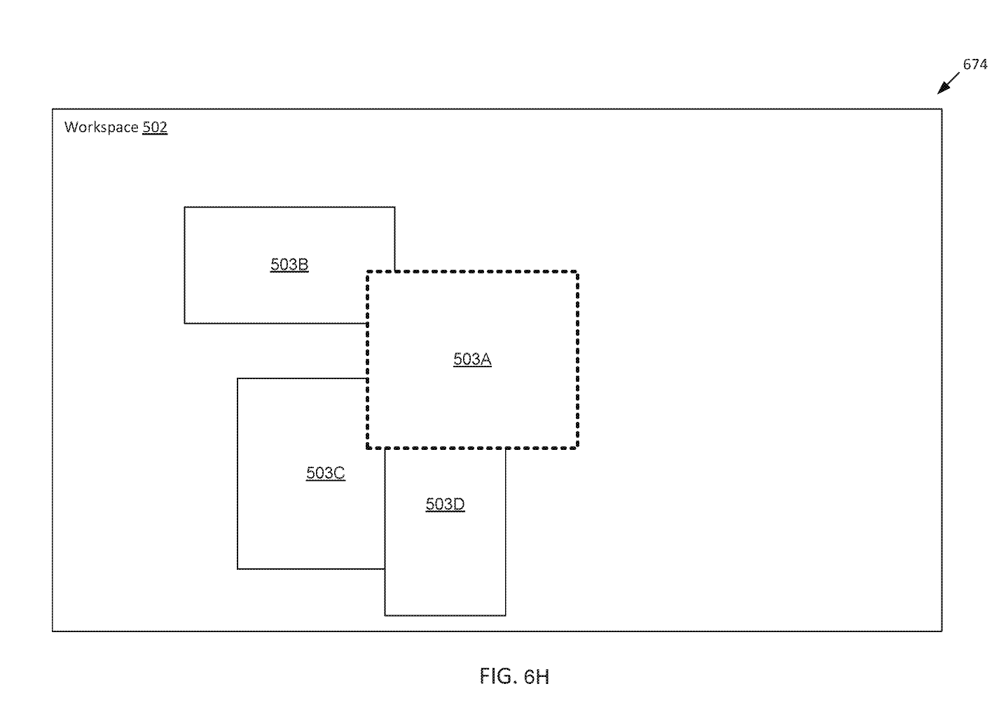

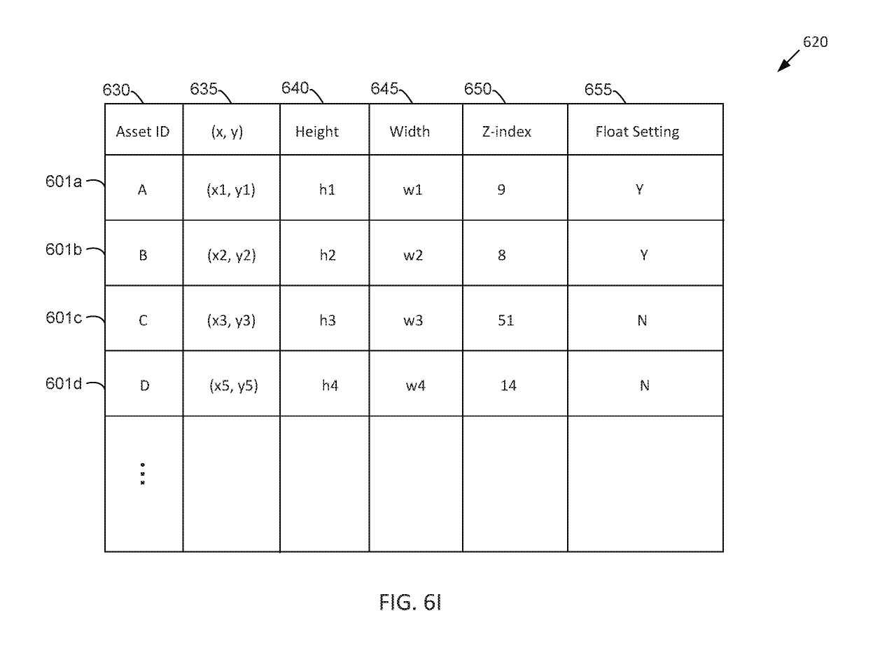

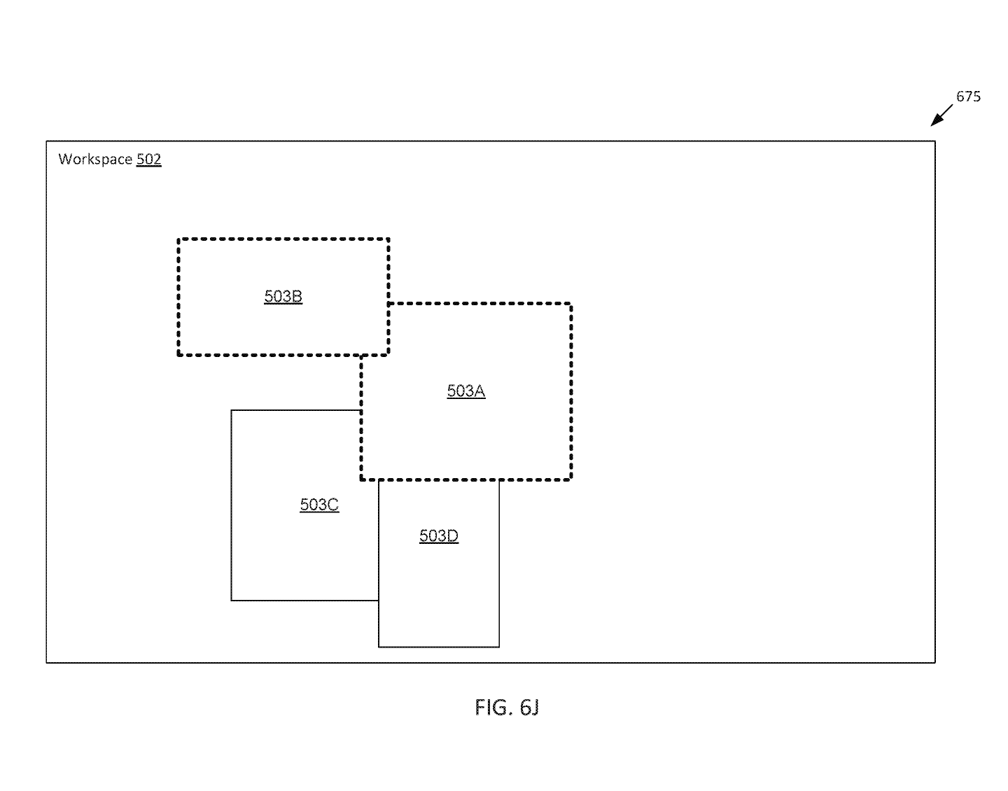

As described below, FIGS. 6A-6J show and describe exemplary screenshots of a sequence of renderings of a workspace 502 (and assets 503 contained therein) and updates made to the asset display data structure 620. Each rendering shown in the Figures described below may comprise a distinct temporal rendering of the workspace 502. The below sequence of renderings is provided for illustrative purposes to illustrate a floating asset feature of the workspace 502. In other embodiments, however, other sequences of workspace renderings may be used.

FIG. 6A shows a conceptual diagram of an initial/first asset display data structure 620, according to various embodiments of the present invention. For example, the first asset display data structure 620 may be retrieved by the communication infrastructure 210 (e.g., from the collaboration server 310 or database server 320) at the start of a session for a particular workspace 502 and transmitted to each appliance 140 participating in the session.

As shown, the first asset display data structure 620 comprises a plurality of entries 601, each entry 601 representing a particular asset 503 associated with the workspace 502. For example, the plurality of entries 601 may include an entry for each of assets A (503A), B (503B), C (503C), and D (503D) associated with the workspace 502. Each entry 601 contains a plurality of data fields, including asset ID 630, x and y coordinates 635, height value 640, width value 645, z-index value 650, and a float setting indicator 655. The asset ID 630 may uniquely identify each asset associated with the workspace. The x and y coordinates 635 may indicate the position of the asset within the workspace, such as x and y pixel coordinates of the upper left corner of the asset. The height value 640 and width value 645 may indicate the size of the asset within the workspace, such as height and width pixel values of the asset. The x and y coordinates 635, height value 640, and width value 645 may determine the position and size of the asset when displayed/rendered in the workspace.

The z-index value 650 may indicate the height or depth of the asset relative to and along a z-axis. The z-axis may comprise imaginary representative z-axis relative to a user viewing and facing the workspace. The z-index values of multiple assets are used to produce a stacking or layering order of the assets 503 when displayed/rendered in the workspace 502. Each z-index value may correspond to a separate and distinct rendering layer. The stacking/layering order of a first asset 503 is determined by the z-index value of the first asset relative to the z-index values of other assets 503 in the same workspace. When a first asset has a higher stacking/layering order than a second asset in the same workspace, this indicates that the first asset is displayed/rendered in the foreground and in front of the second asset in the same workspace. Thus, if the first and second assets spatially overlap to any degree, in terms of appearance the first asset may partially or completely cover/obscure the second asset due to the higher stacking/layering order of the first asset, that is the first asset may partially or completely render/display in the region that would otherwise be partially or completely rendered/displayed by the second asset.

Different schemes for z-index values may be used to determine the stacking/layering order of the multiple assets 503 of the workspace 502. For example, a lower z-index value may indicate a higher stacking order. In this scheme, a first asset having a lower z-index value than a second asset has a higher stacking order or prioritized render order, i.e. a value that would place the asset in a rendering order, where the rendering of the lower z-index value asset renders in a manner that completely or partially conveys the first in the region where the first and second assets spatially overlap, than the second asset and thus be displayed/rendered in front of the second asset. However, in another scheme, a higher z-index value may indicate a higher stacking order. In this other scheme, a first asset having a higher z-index value than a second asset has a higher stacking order than the second asset and thus be displayed/rendered in front of the second asset. In the embodiments described below, a lower z-index value indicates a higher stacking order. However, in other embodiments, a higher z-index value may indicate a higher stacking order.

The float setting indicator 655 indicates if the float setting has been applied to the asset by a user to produce a floating asset. In some embodiments, a floating asset is assigned a z-index value that indicates a higher stacking/layering order than all non-floating assets in the same workspace. In these embodiments, the floating asset retains the higher stacking order over all non-floating assets in the same workspace regardless of any subsequent user interactions with the floating asset and/or non-floating assets. Thus, the float setting for the asset persists during the session, until the float setting is turned off by a user. In this manner, a floating asset is never covered/obscured by any non-floating asset in the same workspace during the session, since the persistent higher stacking order of the floating asset effectively prevents displaying/rendering of a non-floating asset in front of the floating asset during the session. In other embodiments, a float setting applied to a first asset in a first workspace of a project is then automatically applied to the first asset in all other workspaces of the same project (e.g., a second workspace and a third workspace of the same project) to produce a first floating asset in each of the workspaces of the project. In further embodiments, separate tables for the floating assets and non-floating assets may be maintained, the floating assets being rendered in combination of the separate non-floating assets as determined by the floating asset table and separate non-floating asset table.

In some embodiments, the z-index values associated with all assets (floating and non-floating assets) in the workspace is contained within a predetermined overall range of values. The overall range of values may comprise a first subset of values and a second subset of values, the first subset of values indicating a higher stacking order than the second subset of values. Thus, each and every z-index value within the first subset of values always indicates a higher stacking order than each and every z-index value within the second subset of values. In these embodiments, a z-index value assigned to each floating asset is within the first subset of values and a z-index value assigned to each non-floating asset is within the second subset of values.

In the examples below, the predetermined overall range of z-index values is from 2-100. The first subset of values may comprise values 2-10 and the second subset of values may comprise values 11-100. Thus, each floating asset in the workspace is assigned a z-index value between 2-10 and each non-floating asset in the workspace is assigned a z-index value between 11-100. In the example of FIG. 6A, none of the assets A-D have yet been set as a floating asset. Therefore, all assets A-D have an associated z-index value within the second subset of values from 11-100.

Each appliance 140 may receive (from the communication infrastructure 210) the first asset display data structure 620 and display/render the workspace 502 according to the first asset display data structure 620. FIG. 6B is a screenshot 671 of a first temporal rendering of a workspace 502 based on the first asset display data structure 620 of FIG. 6A, according to various embodiments of the present invention. The assets A (503A), B (503B), C (503C), and D (503D) are displayed within the workspace 502 according to the position, size, and z-index values in the first asset display data structure 620. As shown, since asset A has a higher z-index value than both assets B and C (indicating a lower stacking order than both assets B and C), asset A is displayed/rendered behind both assets B and C. Consequently, when asset A spatially overlaps to any degree with assets B and/or C, asset A may be partially or completely covered/obscured by assets B and/or C due to the lower stacking/layering order of asset A relative to assets B and C.

A user at any appliance 140 may then interact with any asset 503 displayed in the workspace 502 to apply the float setting to the asset 503. For example, the user may interact with asset A (503A) to apply the float setting to asset A for producing a floating asset A. For example, a float setting for an asset may be assigned through an interactive Side-Menu that appears next to the asset when the user selects the asset. The Side-Menu may also be used to deselect the float setting for a floating asset using similar steps. The communication infrastructure 210 may receive the user interaction and update the asset display data structure 620 to reflect the user interaction. In other embodiments, the communication infrastructure 210 may also automatically apply the float setting for an asset received in the current workspace to all other workspaces in the same project. As discussed above, the communication infrastructure 210 maintains and updates an asset display data structure 620 for each workspace 502 of a project 501 during sessions for the project 501. The communication infrastructure 210 may update the asset display data structure 620 for each workspace 502 in the project to reflect a float setting for an asset received in an of the workspaces during a session. In this manner, a float setting applied to a first asset in a first workspace of a project is then automatically applied to the first asset in all other workspaces of the same project.

FIG. 6C shows a conceptual diagram of a second asset display data structure 620, according to various embodiments of the present invention. In the example of FIG. 6C, the second asset display data structure 620 is updated to reflect the user applying the float setting to asset A. As shown, the entry 601a representing asset A is updated with new values for the z-index 650 and the float setting indicator 655. The float setting indicator 655 is changed from “No” to “Yes” and the z-index value 650 is changed from 72 to 9. As discussed above, when an asset is set to a floating asset, the z-index of the floating asset is assigned a value within the first subset of values (e.g., from 2-10) which indicates a higher stacking order than any non-floating asset in the workspace 502.

Each appliance 140 may receive (from the communication infrastructure 210) the updated second asset display data structure 620 and display/render the workspace 502 according to the second asset display data structure 620. FIG. 6D is a screenshot 672 of a second temporal rendering of a workspace 502 based on the second asset display data structure 620 of FIG. 6C, according to various embodiments of the present invention. As shown, asset A is now displayed/rendered in front of both assets B and C due to the now higher stacking order of asset A relative to both assets B and C. Consequently, when asset A spatially overlaps with assets B and/or C, asset A is not covered/obscured by assets B and/or C. In other embodiments, the floating assets may be assigned to one or more displays within a collaboration. For example, one display may be the active master display performing a presentation and the floating asset may or may not be displayed on the active master display. As example, on the master display performing the presentation, a floating asset (such as a company logo) may be displayed on all other displays within the collaboration session but not on the master display so that the floating asset is not the way or a nuisance to the presenter on the master display. On the master display, the floating asset may be turned off or ghosted on the master display while still being displayed on all other collaboration displays.

In some embodiments, a floating asset is displayed with a modified and different visual appearance than non-floating assets to visually indicate the float setting for the asset. In the example of FIG. 6D, the visual appearance of the presentation window of asset A is modified after asset A is set as a floating asset, whereby the modified presentation window of floating asset A has a bold dashed line. In other embodiments, the visual appearance of a floating asset may be modified or differentiated or may have a floating asset indicated label from the non-floating assets in a different manner.

A user at any appliance 140 may then interact with asset B (503B) by selecting asset B. The communication infrastructure 210 may receive the user interaction and update the asset display data structure 620 to reflect the user interaction. FIG. 6E shows a conceptual diagram of an updated third asset display data structure 620, according to various embodiments of the present invention. In the example of FIG. 6E, the asset display data structure 620 is updated to reflect the user selecting the non-floating asset B. In some embodiments, when a user interacts with a non-floating asset, the z-index of the non-floating asset may be set to a value that indicates a higher stacking order than any of the other non-floating assets, but is still within the second subset of values (e.g., from 11-100). For example, the z-index 650 in the entry 601b representing asset B may be changed from 65 to 15. The updated z-index value associated with asset B indicates a higher stacking order than any of the other non-floating assets C and D in the same workspace 502, but still indicates a lower stacking order than floating asset A (since the updated z-index value is still within the second subset of values).

Each appliance 140 may receive (from the communication infrastructure 210) the updated third asset display data structure 620 and display/render the workspace 502 according to the third asset display data structure 620. FIG. 6F is a screenshot 673 of a third temporal rendering of a workspace 502 based on the third asset display data structure 620 of FIG. 6E, according to various embodiments of the present invention. As shown, asset A is still displayed/rendered in asset B due to the retained higher stacking order of asset A relative to asset B, regardless of the just previous user interaction with asset B. Consequently, even though asset A spatially overlaps with asset B, asset A is still not covered/obscured by asset B.

A user at any appliance 140 may then interact with asset D (503D) by selecting and moving asset D to a new position within the workspace 502. The communication infrastructure 210 may receive the user interaction and update the asset display data structure 620 to reflect the user interaction. FIG. 6G shows a conceptual diagram of an updated fourth asset display data structure 620, according to various embodiments of the present invention. In the example of FIG. 6G, the asset display data structure 620 is updated to reflect a user selecting and moving the non-floating asset D to a new position in the workspace 502.

As discussed above, when a user interacts with a non-floating asset, the z-index of the non-floating asset may be set to a value that indicates a higher stacking order than any of the other non-floating assets, but is still within the second subset of values (e.g., from 11-100). For example, the z-index 650 in the entry 601d representing asset D may be changed from 33 to 14. The updated z-index value associated with asset D indicates a higher stacking order than any of the other non-floating assets B and C in the same workspace 502, but still indicates a lower stacking order than floating asset A (since the updated z-index value is still within the second subset of values). Also, the x and y coordinates 635 are updated to indicate the new position of asset D within the workspace 502. The above process may also be applied to each new non-floating asset that are added to the workspace by the user. In this case, the z-index of the new non-floating asset may be set to a value that indicates a higher stacking order than any of the other non-floating assets, but is still within the second subset of values (e.g., from 11-100). Thus, the z-index value associated with the new non-floating asset indicates a higher stacking order than any of the other non-floating assets in the same workspace 502, but still indicates a lower stacking order than all floating assets.

Each appliance 140 may receive (from the communication infrastructure 210) the updated fourth asset display data structure 620 and display/render the workspace 502 according to the fourth asset display data structure 620. FIG. 6H is a screenshot 674 of a fourth temporal rendering of a workspace 502 based on the fourth asset display data structure 620 of FIG. 6G, according to various embodiments of the present invention. As shown, asset D is displayed in a new position in the workspace 502. Also, non-floating asset D is displayed/rendered in front of non-floating asset C (rendered over the non-floating asset C) due to the higher stacking order of asset D relative to asset C, but is still displayed/rendered behind floating asset A due to the lower stacking order of asset D relative to asset A, regardless of the just previous user interaction with asset D.

A user at any appliance 140 may then interact with asset B (503B) to apply the float setting to asset B for producing a floating asset B. The communication infrastructure 210 may receive the user interaction and update the asset display data structure 620 to reflect the user interaction. FIG. 6I shows a conceptual diagram of a fifth asset display data structure 620, according to various embodiments of the present invention. In the example of FIG. 6I, the fifth asset display data structure 620 is updated to reflect the user applying the float setting to asset B. As shown, the entry 601b representing asset B is updated with new values for the z-index 650 and the float setting indicator 655. The float setting indicator 655 is changed from “No” to “Yes” and the z-index value 650 is changed from 15 to 8. As discussed above, when an asset is set to a floating asset, the z-index of the floating asset is assigned a value within the first subset of values (e.g., from 2-10) which indicates a higher stacking order than any non-floating asset in the workspace 502. In some embodiments, when a second asset is set to a floating asset, the z-index of the second floating asset is also set to a value that indicates a higher stacking order than any other floating asset in the workspace 502. Thus, the asset most recently set as a floating asset has a higher stacking order than any other floating asset in the workspace 502. In the example of FIG. 6I, the z-index of the floating asset B is set to a value of 8, which indicates a higher stacking order than floating asset A.

Each appliance 140 may receive (from the communication infrastructure 210) the updated fifth asset display data structure 620 and display/render the workspace 502 according to the fifth asset display data structure 620. FIG. 6J is a screenshot 675 of a fifth temporal rendering of a workspace 502 based on the fifth asset display data structure 620 of FIG. 6I, according to various embodiments of the present invention. As shown, floating asset B is now displayed/rendered in front of floating asset A due to the now higher stacking order of asset B relative to assets A. Floating asset B is also displayed with a modified and different visual appearance than non-floating assets to visually indicate the float setting for asset B.

As described above, upon a float setting being applied to an asset in the workspace 502, the floating asset has a higher stacking order than all non-floating assets in the workspace. The float setting and the higher stacking order of the floating asset persists throughout the session, regardless of subsequent user interactions with non-floating assets in the workspace (until the float setting is deselected). Thus, the float setting for an asset persists in the workspace 502 during a session. In some embodiments, the float setting for an asset also persists across multiple sessions. In these embodiments, when the session ends and the project 501 and each workspace 502 is closed, the communication infrastructure 210 stores the last state of the asset display data structure 620 for each closed workspace 502 (e.g., stores to the collaboration server 310 and/or the database server 320). The last state of the asset display data structure 620 stores the most current float settings and z-indexes associated with each asset in the workspace 502. Upon a next session for the project 501 beginning, the workspace 502 is re-opened and the communication infrastructure 210 automatically retrieves the last state of the asset display data structure 620 for the workspace 502 having the current float settings and z-indexes of all assets in the workspace 502. Thus, the float setting for an asset may be re-assigned to the asset according to the last state of the asset display data structure 620.

In some embodiments, the float setting applied to a selected asset in a workspace in a project is applied per a default or pre-defined setting to all workspaces in the same project that include the selected asset. For example, a first project may comprise first, second, and third workspaces, each of the workspaces having an associated first asset. During a session with the first workspace, a float setting may be applied to the first asset in the first workspace. Thus, the float setting may be automatically applied to the first asset in the second workspace and the third workspace of the same first project (to produce the first floating asset in each of the workspaces of the first project).

As discussed above, an asset 503 may comprise content sources that are file-based, application-based (e.g., web-based), or Live Source-based. In some embodiments, an asset 503 in a workspace 502 may comprise an application or an instance of an application and different assets 503 in the workspace 502 may comprise different applications and/or different instances of an application. For example, a floating asset may comprise a first application and a non-floating asset may comprise a second application that is different from the first application. As another example, a floating asset may comprise an instance of a first application and a non-floating asset may comprise an instance of a second application that is different from the first application. As a further example, a floating asset may comprise a first instance of a first application and a non-floating asset may comprise a second instance of the first application.

In some embodiments, a display area of an asset 503 is less than the entire display area of the workspace 502. In these embodiments, an asset 503 comprises a subarea of the workspace 502 so that at least one other asset 503 is visible and/or accessible in the workspace 502. Thus, the current display area may comprise a subset area of the workspace.

In some embodiments, when a floating asset spatially overlaps another asset and is displayed in front of the other asset (has a with a higher stacking order than the other asset), the floating asset is assigned a transparency value that allows at least a portion of the other asset that spatially overlaps with the floating asset to be partially visible underneath the floating asset. In these embodiments, the floating asset is not displayed with a solid color background for the floating asset, and any areas in the floating asset that do not contain content can be layered with a transparency to allow assets beneath areas of the floating asset not having content to be partially visible.

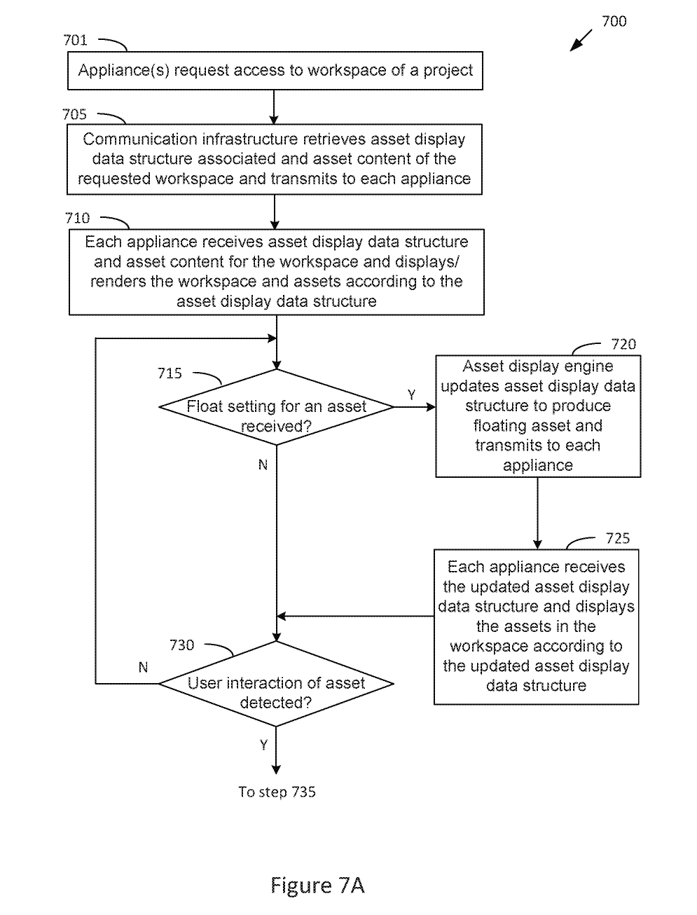

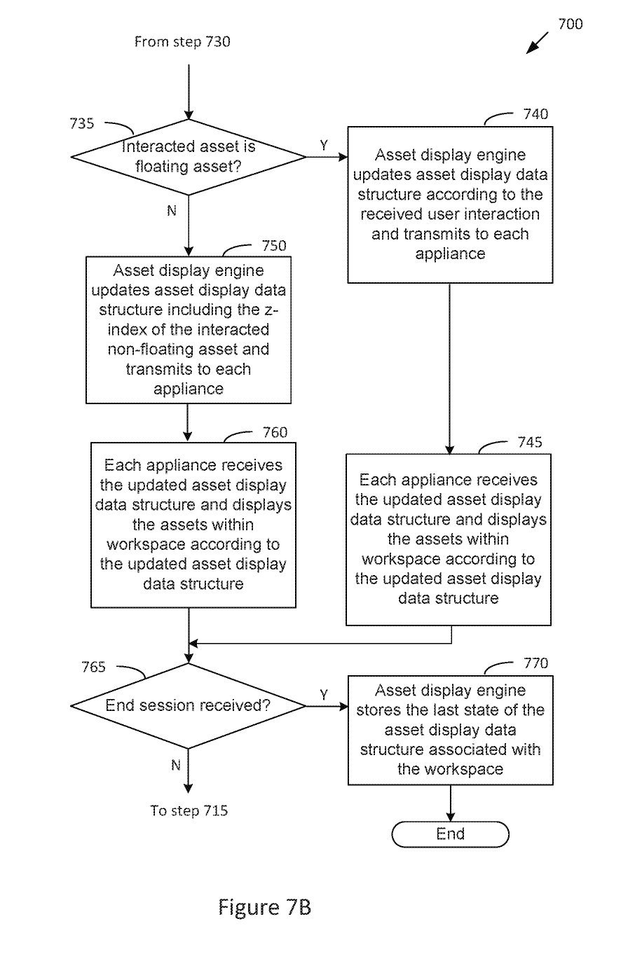

FIGS. 7A-7B set forth a flow diagram of method steps for displaying a floating asset in a workspace, according to various embodiments of the present invention. Although the method steps are described in conjunction with the systems of FIGS. 1-6J, persons skilled in the art will understand that any system configured to perform the method steps, in any order, is within the scope of the present invention.

For context, in various embodiments, the communication infrastructure 210 (comprising an asset display engine 510) may operate in conjunction with one or more display systems 100 (each display system 100 comprising an appliance 140 and a display 120) to perform the method steps of a method 700 of FIGS. 7A-7B. The method 700 may be performed during a collaborative session or non-collaborative/solo session. During a collaborative session, two or more appliances 140 may access and interact with a shared project and workspace via the communication infrastructure 210, whereby the user interactions at each appliance 140 is mirrored/reflected at each of the appliances 140 participating in the collaborative session. During a non-collaborative/solo session, a single appliance 140 may access and interact with a project and workspace on the communication infrastructure 210. In this regard, a collaborative or solo session may be considered a sequence of temporal renderings of the workspace, each rendering being a distinct temporal rendering of the workspace at each appliance 140.

As shown, a method 700 begins at step 701, where one or more appliances 140 request access to a workspace 502 of a project 501 stored on the communication infrastructure 210. In response, the communication infrastructure 210 retrieves (at step 705) a last state of an asset display data structure 620 associated with the requested workspace 502 (e.g., retrieve from the collaboration server 310 and/or the database server 320). The communication infrastructure 210 may maintain and store an asset display data structure 620 for each workspace 502 of each project 501 during collaborative or non-collaborative (solo) sessions for the project 501. The communication infrastructure 210 also retrieves (at step 705) the asset content 331 for one or more digital assets 503 of the requested workspace 502 (e.g., retrieve from the file server 330). The communication infrastructure 210 further transmits (at step 705) the asset display data structure 620 and the asset content 331 for the requested workspace 502 to each appliance 140 participating in the session.

At step 710, each appliance 140 then receives the asset display data structure 620 and the asset content 331 for the workspace 502 and displays/renders the workspace 502 and assets 503 within workspace 502 according to the asset display data structure 620. Each appliance 140 may determine the position, size, and stacking/layering order of each asset 503 within the workspace 502 based on the information contained in the asset display data structure 620. For illustrative purposes, each asset 503 in the workspace 502 is assumed to initially comprise a non-floating asset and has an assigned a z-index value within the second subset of values (e.g., from 11-100).

The asset display engine 510 then determines (at step 715) if a float setting for an asset 503 is received at any appliance 140. The asset display engine 510 may do so by determining whether any appliance 140 has received a user interaction selecting a float setting for any asset 503 in the workspace 502. If not (at 715—No), then the method 700 proceeds at step 730.

If so (at 715—Yes), then the asset display engine 510 updates (at step 720) the asset display data structure 620 according to the received user interaction. In particular, the asset display engine 510 updates the entry 601 in the asset display data structure 620 that represents the selected asset so that the float setting indicator 655 is changed from “No” to “Yes” and the z-index 650 is assigned a value within the first subset of values (e.g., from 2-10). If there are other previous floating assets already contained in the workspace 502, then the z-index for the newly selected asset is assigned a value that indicates a higher stacking order than each of the other previous floating assets in the workspace 502 (e.g., is assigned a value that is the next lowest increment from the lowest z-index value of all other previous floating assets). The asset display engine 510 also transmits (at 720) the updated asset display data structure 620 to each appliance 140 participating in the session.

At step 725, each appliance 140 then receives the updated asset display data structure 620 and displays/renders the assets 503 within workspace 502 according to the updated asset display data structure 620. In this manner, the newest floating asset has a higher stacking order than each non-floating asset and all other previous floating assets in the workspace 502, and thus is displayed/rendered in front of each non-floating asset and previous floating assets in the workspace 502 when there is any spatial overlap with any of the non-floating asset and previous floating assets in the workspace 502. The new rendering of the assets 503 within workspace 502 according to the updated asset display data structure 620 may be considered a new distinct temporal rendering of the workspace 502 at each appliance 140.

At step 730, the asset display engine 510 then determines if a user interaction of any asset 503 (referred to as an “interacted asset”) in the workspace 502 is detected/received at any appliance 140. If not (at 730—No), the method 700 proceeds at step 715 where it determines if a float setting is received for any asset. If so (at 730—Yes), the asset display engine 510 further determines (at step 735) whether the interacted asset comprises a floating asset. For example, the asset display engine 510 may do so by checking the float setting indicator 655 in the entry 601 representing the interacted asset in the asset display data structure 620. The asset display engine 510 may determine whether the interacted asset comprises a floating asset since different operations may be applied depending on whether the interacted asset is a floating asset or a non-floating asset.

If the interacted asset is determined to comprise a floating asset (at 735—Yes), the asset display engine 510 then updates (at step 740) the asset display data structure 620 according to the received user interaction. For example, the asset display engine 510 may update the position (x and y coordinates 635) and size (height value 640 and width value 645) in the entry 601 representing the interacted floating asset if the interacted floating asset has been moved and/or resized. In some embodiments, when a user interacts with a floating asset (other than selecting/deselecting the float setting), the z-index 650 assigned to the floating asset is not updated and does not change. The asset display engine 510 also transmits (at 740) the updated asset display data structure 620 to each appliance 140 participating in the session.

At step 745, each appliance 140 then receives the updated asset display data structure 620 and displays/renders the assets 503 within workspace 502 according to the updated asset display data structure 620. The new rendering of the assets 503 within workspace 502 according to the updated asset display data structure 620 may be considered a new distinct temporal rendering of the workspace 502 at each appliance 140. The method 700 then proceeds to step 765.

If the interacted asset is determined to not comprise a floating asset (at 735—No), this indicates the interacted asset comprises a non-floating asset. The asset display engine 510 then updates (at step 750) the asset display data structure 620 according to the received user interaction. For example, the asset display engine 510 may update the position (x and y coordinates 635) and size (height value 640 and width value 645) in the entry 601 representing the interacted non-floating asset if the interacted non-floating asset has been moved and/or resized. In addition, the asset display engine 510 also updates the z-index 650 associated with the interacted non-floating asset in the entry 601 representing the interacted non-floating asset in the asset display data structure 620. For example, the z-index 650 of the interacted non-floating asset may be set to a value that indicates a higher stacking order than any of the other non-floating assets in the workspace 502, but is still within the second subset of values (e.g., from 11-100). The asset display engine 510 also transmits (at 750) the updated asset display data structure 620 to each appliance 140 participating in the session.

At step 760, each appliance 140 then receives the updated asset display data structure 620 and displays/renders the assets 503 within workspace 502 according to the updated asset display data structure 620. In this manner, the interacted non-floating asset has a higher stacking order than all other non-floating assets, but still has a lower stacking order than all floating assets in the workspace 502 so as not to be displayed in front of and obscure any floating asset in the workspace 502. The new rendering of the assets 503 within workspace 502 according to the updated asset display data structure 620 may be considered a new distinct temporal rendering of the workspace 502 at each appliance 140.

The asset display engine 510 then determines (at step 765) if an “end session” request is received at any appliance 140. If so (at step 765—Yes), the asset display engine 510 then stores (at step 770) the last state of the asset display data structure 620 associated with the workspace 502 (e.g., stores to the collaboration server 310 and/or the database server 320) so that the last state of the asset display data structure 620 and the workspace 502 persists to a next future session. The method 700 then ends. If not (at 765—No), the method 700 proceeds at step 715 where it determines if a float setting is received for any asset.

In sum, a communication infrastructure 210 causes a workspace 502 comprising a plurality of assets 503 to be displayed/rendered at each appliance 140 in a session. A float setting may be applied by a user to an asset to produce a floating asset. A floating asset is assigned a z-index value that indicates a higher stacking/layering order than all non-floating assets in the same workspace. In these embodiments, the floating asset retains the higher stacking order over all non-floating assets in the same workspace regardless of any subsequent user interactions with the floating asset and/or non-floating assets. Thus, the float setting for the asset persists during the session, until the float setting is turned off by the user. In this manner, a floating asset is never covered/obscured by any non-floating asset in the same workspace during the session, since the persistent higher stacking order of the floating asset effectively prevents displaying/rendering of a non-floating asset in front of the floating asset during the session.

At least one advantage of the disclosed technique is that an asset may be selected as a floating asset that has a higher stacking order than non-floating assets. By virtue of the higher stacking order, the floating asset is persistently displayed in the foreground in front of non-floating assets in the workspace. A further advantage of the disclosed technique is that the floating asset is persistently displayed in the foreground regardless of any user interactions with any of the non-floating assets in the workspace so that a non-floating asset does not obscure the floating asset in during collaborative or non-collaborative (solo) sessions.

Aspects of the subject matter described herein are set out in the following numbered clauses.

1. A computer-implemented method for displaying assets in a workspace, the method comprising: assigning a float setting to a first asset to produce a first floating asset in a first workspace; subsequently detecting an interaction with a second asset in the first workspace; and in response, rendering the first floating asset in the first workspace with a higher stacking order than the second asset.

2. The computer-implemented method of clause 1, further comprising receiving a selection of the float setting for the first asset.

3. The computer-implemented method of any of clauses 1-2, further comprising, in response to detecting the interaction with the second asset and before rendering the first floating asset in the workspace, determining that the first floating asset is assigned the float setting and that the second asset is not assigned a float setting.

4. The computer-implemented method of any of clauses 1-3, wherein: the first floating asset comprises an instance of a first application; and the second asset comprises an instance of a second application that is different than the first application.

5. The computer-implemented method of any of clauses 1-4, wherein: a first project comprises a plurality of workspaces including the first workspace, each workspace in the plurality of workspaces including the first asset; and the float setting assigned to the first asset is automatically applied to each of the plurality of workspaces comprising the first project to produce the first floating asset in each of the plurality of workspaces.

6. The computer-implemented method of any of clauses 1-5, further comprising: assigning a float setting to a third asset to produce a second floating asset in the first workspace; and rendering the second floating asset in the first workspace with a higher stacking order than the first floating asset.

7. The computer-implemented method of any of clauses 1-6, wherein: the second asset spatially overlaps the first asset in the first workspace; and the first floating asset is at least partially transparent, allowing at least a portion of the second asset that spatially overlaps with the first floating asset to be visible.

8. The computer-implemented method of any of clauses 1-7, wherein rendering the first floating asset in the first workspace with a higher stacking order than the second asset comprises displaying the first floating asset in front of the second asset in the first workspace.

9. The computer-implemented method of any of clauses 1-8, wherein rendering the first floating asset in the first workspace with a higher stacking order than the second asset comprises temporally rendering the first floating asset in front of the second asset in the first workspace, wherein each temporal rendering comprises a separate and distinct rendering included in a sequence of temporal renderings produced during a session.

10. A non-transitory computer-readable medium storing program instructions that, when executed by a processor, cause the processor to display assets in a workspace, by performing the steps of: assigning a float setting to a first asset to produce a first floating asset in a first workspace; subsequently detecting an interaction with a second asset in the first workspace; and in response, rendering the first floating asset in the first workspace with a higher stacking order than the second asset.

11. The non-transitory computer-readable medium of clause 10, further comprising: receiving a selection of the float setting for the first asset.

12. The non-transitory computer-readable medium of any of clauses 10-11, further comprising: in response to detecting the interaction with the second asset and before displaying the first floating asset with the higher stacking order than the second asset, determining that the first floating asset is associated with a first z-index and the second asset is associated with a second z-index, wherein the first z-index indicates a higher stacking order than the second z-index.

13. The non-transitory computer-readable medium of any of clauses 10-12, wherein: a z-index associated with each asset in the first workspace is within a predetermined range of values comprising a first subset of values and a second subset of values, the first subset of values indicating a higher stacking order than the second subset of values; a z-index associated with each floating asset in the first workspace is within the first subset of values; and a z-index associated with each non-floating asset in the first workspace is within the second subset of values.

14. The non-transitory computer-readable medium of any of clauses 10-13, wherein the first floating asset comprises an instance of a first application, the second asset comprises an instance of a second application that is different than the first application.

15. The non-transitory computer-readable medium of any of clauses 10-14, wherein: a first project comprises a plurality of workspaces including the first workspace, each workspace in the plurality of workspaces including the first asset; and the float setting assigned to the first asset is automatically applied to each of the plurality of workspaces comprising the first project to produce the first floating asset in each of the plurality of workspaces.

16. The non-transitory computer-readable medium of any of clauses 10-15, further comprising: assigning a float setting to a third asset to produce a second floating asset in the first workspace; and displaying the second floating asset in the first workspace with a higher stacking order than the first floating asset.

17. The non-transitory computer-readable medium of any of clauses 10-16, wherein: the second asset spatially overlaps the first asset in the first workspace; and displaying the first floating asset in the first workspace with a higher stacking order than the second asset comprises displaying the first floating asset in front of the second asset in the first workspace.

18. The non-transitory computer-readable medium of any of clauses 10-17, wherein: displaying the first floating asset in the first workspace with a higher stacking order than the second asset comprises temporally rendering the first floating asset in front of the second asset in the first workspace, wherein each temporal rendering comprises a separate and distinct rendering included in a sequence of temporal renderings produced during a session.

19. A computer-implemented method for displaying assets in a workspace, the method comprising: receiving, from a first client device, a selection of a float setting for a first asset in a first workspace; assigning the float setting to the first asset to produce a first floating asset; detecting, at a second client device, an interaction with a second asset in the first workspace; and in response, rendering at both the first client device and a second client device the first floating asset in the first workspace with a higher stacking order than the second asset.

20. A non-transitory computer-readable medium storing program instructions that, when executed by a processor, cause the processor to display assets in a workspace, by performing the steps of: receiving, from a first client device, a selection of a float setting for a first asset in a first workspace; assigning the float setting to the first asset to produce a first floating asset; detecting, at a second client device, an interaction with a second asset in the first workspace; and in response, displaying at both the first client device and a second client device the first floating asset in the first workspace with a higher stacking order than the second asset.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” “engine,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

The invention claimed is:

1. A computer-implemented method for displaying assets in a workspace, the method comprising:
assigning a float setting to a first asset to produce a first floating asset in a first workspace;
subsequently detecting an interaction with a second asset in the first workspace; and
in response, rendering the first floating asset in the first workspace with a higher stacking order than the second asset.

2. The computer-implemented method of claim 1, further comprising receiving a selection of the float setting for the first asset.

3. The computer-implemented method of claim 1, further comprising, in response to detecting the interaction with the second asset and before rendering the first floating asset in the workspace, determining that the first floating asset is assigned the float setting and that the second asset is not assigned a float setting.

4. The computer-implemented method of claim 1, wherein:
the first floating asset comprises an instance of a first application; and
the second asset comprises an instance of a second application that is different than the first application.

5. The computer-implemented method of claim 1, wherein:
a first project comprises a plurality of workspaces including the first workspace, each workspace in the plurality of workspaces including the first asset; and
the float setting assigned to the first asset is automatically applied to each of the plurality of workspaces comprising the first project to produce the first floating asset in each of the plurality of workspaces.

6. The computer-implemented method of claim 1, further comprising:
assigning a float setting to a third asset to produce a second floating asset in the first workspace; and
rendering the second floating asset in the first workspace with a higher stacking order than the first floating asset.

7. The computer-implemented method of claim 1, wherein:
the second asset spatially overlaps the first asset in the first workspace; and
the first floating asset is at least partially transparent, allowing at least a portion of the second asset that spatially overlaps with the first floating asset to be visible.

8. The computer-implemented method of claim 1, wherein rendering the first floating asset in the first workspace with a higher stacking order than the second asset comprises displaying the first floating asset in front of the second asset in the first workspace.

9. The computer-implemented method of claim 1, wherein rendering the first floating asset in the first workspace with a higher stacking order than the second asset comprises temporally rendering the first floating asset in front of the second asset in the first workspace, wherein each temporal rendering comprises a separate and distinct rendering included in a sequence of temporal renderings produced during a session.

10. A non-transitory computer-readable medium storing program instructions that, when executed by a processor, cause the processor to display assets in a workspace, by performing the steps of:
assigning a float setting to a first asset to produce a first floating asset in a first workspace;
subsequently detecting an interaction with a second asset in the first workspace; and
in response, rendering the first floating asset in the first workspace with a higher stacking order than the second asset.

11. The non-transitory computer-readable medium of claim 10, further comprising:
receiving a selection of the float setting for the first asset.

12. The non-transitory computer-readable medium of claim 10, further comprising:
in response to detecting the interaction with the second asset and before displaying the first floating asset with the higher stacking order than the second asset, determining that the first floating asset is associated with a first z-index and the second asset is associated with a second z-index, wherein the first z-index indicates a higher stacking order than the second z-index.

13. The non-transitory computer-readable medium of claim 12, wherein:
a z-index associated with each asset in the first workspace is within a predetermined range of values comprising a first subset of values and a second subset of values, the first subset of values indicating a higher stacking order than the second subset of values;
a z-index associated with each floating asset in the first workspace is within the first subset of values; and
a z-index associated with each non-floating asset in the first workspace is within the second subset of values.

14. The non-transitory computer-readable medium of claim 10, wherein the first floating asset comprises an instance of a first application, the second asset comprises an instance of a second application that is different than the first application.

15. The non-transitory computer-readable medium of claim 10, wherein:
a first project comprises a plurality of workspaces including the first workspace, each workspace in the plurality of workspaces including the first asset; and
the float setting assigned to the first asset is automatically applied to each of the plurality of workspaces comprising the first project to produce the first floating asset in each of the plurality of workspaces.

16. The non-transitory computer-readable medium of claim 10, further comprising:
assigning a float setting to a third asset to produce a second floating asset in the first workspace; and
displaying the second floating asset in the first workspace with a higher stacking order than the first floating asset.

17. The non-transitory computer-readable medium of claim 10, wherein:
the second asset spatially overlaps the first asset in the first workspace; and
displaying the first floating asset in the first workspace with a higher stacking order than the second asset comprises displaying the first floating asset in front of the second asset in the first workspace.

18. The non-transitory computer-readable medium of claim 10, wherein:
displaying the first floating asset in the first workspace with a higher stacking order than the second asset comprises temporally rendering the first floating asset in front of the second asset in the first workspace, wherein each temporal rendering comprises a separate and distinct rendering included in a sequence of temporal renderings produced during a session.

19. A computer-implemented method for displaying assets in a workspace, the method comprising:
receiving, from a first client device, a selection of a float setting for a first asset in a first workspace;
assigning the float setting to the first asset to produce a first floating asset;
detecting, at a second client device, an interaction with a second asset in the first workspace; and
in response, rendering at both the first client device and a second client device the first floating asset in the first workspace with a higher stacking order than the second asset.

20. A non-transitory computer-readable medium storing program instructions that, when executed by a processor, cause the processor to display assets in a workspace, by performing the steps of:
receiving, from a first client device, a selection of a float setting for a first asset in a first workspace;
assigning the float setting to the first asset to produce a first floating asset;
detecting, at a second client device, an interaction with a second asset in the first workspace; and
in response, displaying at both the first client device and a second client device the first floating asset in the first workspace with a higher stacking order than the second asset.
